(19) United States
(12) Patent Application Publication
(10) Pub. No.: US 2021/0004962 A1
(43) Pub. Date: Jan. 7, 2021

(54) GENERATING EFFECTS ON IMAGES USING DISPARITY GUIDED SALIENT OBJECT DETECTION

(71) Applicant: QUALCOMM Incorporated, San Diego, CA (US)

(72) Inventors: Chung-Chi TSAI, San Diego, CA (US); Shang-Chih CHUANG, San Diego, CA (US); Xiaoyun JIANG, San Diego, CA (US)

(21) Appl. No.: 16/460,860

(22) Filed: Jul. 2, 2019

(51) Int. Cl. G06T 7/11; G06T 5/00; G06T 7/90; G06K 9/72

(52) U.S. Cl. CPC G06T 7/11; G06T 5/003; G06T 2207/20164; G06K 9/726; G06T 2207/20084; G06T 7/90

(57) ABSTRACT

Systems, methods, and computer-readable media are provided for generating an image processing effect via disparity-guided salient object detection. In some examples, a system can detect a set of superpixels in an image; identify, based on a disparity map generated for the image, an image region containing at least a portion of a foreground of the image; calculate foreground queries identifying superpixels in the image region having higher saliency values than other superpixels in the image region; rank a relevance between each superpixel and one or more foreground queries; generate a saliency map for the image based on the ranking of the relevance between each superpixel and the one or more foreground queries; and generate, based on the saliency map, an output image having an effect applied to a portion of the output image.

### TECHNICAL FIELD

The present disclosure generally relates to image processing, and more specifically to generating effects on images using disparity guided salient object detection.

### BACKGROUND

The increasing versatility of digital camera products has allowed digital cameras to be integrated into a wide array of devices and has expanded their use to new applications. For example, phones, drones, cars, computers, televisions, and many other devices today are often equipped with cameras. The cameras allow users to capture images from any device equipped with a camera. The images can be captured for recreational use, professional photography, surveillance, and automation, among other applications. Moreover, cameras are increasingly equipped with specific functionalities for modifying images or creating artistic effects on the images. For example, many cameras are equipped with image processing capabilities for generating different effects on captured images.

Many image processing techniques implemented today rely on image segmentation algorithms that divide an image into multiple segments which can be analyzed or processed to produce specific image effects. Some example practical applications of image segmentation include, without limitation, chroma key compositing, feature extraction, recognition tasks (e.g., object and face recognition), machine vision, medical imaging, and depth-of-field (or “bokeh”) effects. However, current image segmentation techniques can often yield poor segmentation results and, in many cases, are only suitable for a specific type of image.

### BRIEF SUMMARY

Disclosed herein are systems, methods, and computer-readable media for generating an image processing effect. According to at least one example, a method is provided for generating an image processing effect. An example method can include identifying at least one superpixel in a foreground region of an image, each superpixel including two or more pixels and the at least one superpixel having a higher saliency value than one or more other superpixels in the image; ranking a relevance between the at least one superpixel and each superpixel from the one or more other superpixels in the image; and generating a saliency map for the image based on the ranking of the relevance between the at least one superpixel and each superpixel from the one or more other superpixels in the image.

According to at least some examples, apparatuses are provided for generating an image processing effect. In one example, an example apparatus can include memory and one or more processors configured to identify at least one superpixel in a foreground region of an image, each superpixel including two or more pixels and the at least one superpixel having a higher saliency value than one or more other superpixels in the image; rank a relevance between the at least one superpixel and each superpixel from the one or more other superpixels in the image; and generate a saliency map for the image based on the ranking of the relevance between the at least one superpixel and each superpixel from the one or more other superpixels in the image.

In another example, an apparatus can include means for identifying at least one superpixel in a foreground region of an image, each superpixel including two or more pixels and the at least one superpixel having a higher saliency value than one or more other superpixels in the image; ranking a relevance between the at least one superpixel and each superpixel from the one or more other superpixels in the image; and generating a saliency map for the image based on the ranking of the relevance between the at least one superpixel and each superpixel from the one or more other superpixels in the image.

According to at least one example, non-transitory computer-readable media are provided for generating an image processing effect. An example non-transitory computer-readable medium can store instructions that, when executed by one or more processors, cause the one or more processor to identify at least one superpixel in a foreground region of an image, each superpixel including two or more pixels and the at least one superpixel having a higher saliency value than one or more other superpixels in the image; rank a relevance between the at least one superpixel and each superpixel from the one or more other superpixels in the image; and generate a saliency map for the image based on the ranking of the relevance between the at least one superpixel and each superpixel from the one or more other superpixels in the image.

In some aspects, the methods, apparatuses, and computer-readable media described above can further detect a set of features in the image. In some cases, the ranking of the relevance between the at least one superpixel and each superpixel from the one or more other superpixels in the image can be at least partly based on the set of features detected in the image. In some implementations, the set of features can be detected using a convolutional neural network. Moreover, the set of features can include semantic features, texture information, and/or color components.

In some aspects, the methods, apparatuses, and computer-readable media described above can further generate, based on the saliency map, an edited output image having an effect applied to a portion of the image. In some cases, the effect can be a blurring effect, and the portion of the image can include a background image region. Moreover, the blurring effect can include, for example, a depth-of-field effect where the background image region is at least partly blurred, and the foreground region of the image is at least partly in focus.

In some aspects, the methods, apparatuses, and computer-readable media described above can further detect a set of superpixels in the image, wherein the set of superpixels include the at least one superpixel, and the one or more other superpixels and each superpixel in the set of superpixels includes at least two pixels; and generate a graph representing the image, the graph identifying a spatial relationship between at least one of the set of superpixels and a set of features extracted from the image. In some cases, the ranking of the relevance between the at least one superpixel and each superpixel from the one or more other superpixels in the image can be based on the graph and the at least one superpixel having the higher saliency value than the one or more other superpixels in the image.

In some aspects, the methods, apparatuses, and computer-readable media described above can further identify, based on a disparity map generated for the image, a region of interest in the image, the region of interest including at least a portion of the foreground region of the image. In some examples, identifying the region of interest in the image can include generating a spatial prior map of the image based on a set of superpixels in the image, the set of superpixels including the at least one superpixel and the one or more other superpixels; generating a binarized disparity map based on the disparity map generated for the image; multiplying the spatial prior map with the binarized disparity map; and identifying the region of interest in the image based on an output generated by multiplying the spatial prior map with the binarized disparity map.

In some implementations, the disparity map can be generated based on autofocus information from an image sensor that captured the image, and the binarized disparity map can identify at least a portion of the foreground region in the image based on one or more associated disparity values.

In some implementations, identifying the at least one superpixel in the foreground region of the image can include calculating mean saliency values for superpixels in the image, each of the superpixels including two or more pixels; identifying the at least one superpixel having the higher mean saliency value than the one or more other superpixels in the image; and selecting the at least one superpixel as a foreground query. In some examples, the ranking of the relevance between the at least one superpixel and each superpixel from the one or more other superpixels in the image can include ranking the relevance between the foreground query and each superpixel from the one or more other superpixels.

In some cases, the ranking of the relevance between the at least one superpixel and each superpixel from the one or more other superpixels in the image can be based on one or more manifold ranking functions, wherein an input of the one or more manifold ranking functions can include a set of superpixels in the image, the at least one superpixel in the foreground region of the image, and/or a set of features extracted from the image. Moreover, in some cases, the ranking of the relevance between the at least one superpixel and each superpixel from the one or more other superpixels in the image can include generating a ranking map based on a set of superpixels in the image, the at least one superpixel in the foreground region of the image, and/or a set of features extracted from the image, and the saliency map can be generated based on the ranking map.

In some implementations, generating the saliency map can include applying a pixel-wise saliency refinement model to the ranking map, the pixel-wise saliency refinement model including a fully-connected conditional random field or an image matting model; and generating the saliency map based on a result of applying the pixel-wise saliency refinement model to the ranking map.

In some aspects, the methods, apparatuses, and computer-readable media described above can further binarize the saliency map; generate one or more foreground queries based on the binarized saliency map, the one or more foreground queries including one or more superpixels in the foreground region of the image; generate an updated ranking map based on the one or more foreground queries and the set of superpixels in the image; apply the pixel-wise saliency refinement model to the updated ranking map; and generate a refined saliency map based on an additional result of applying the pixel-wise saliency refinement model to the updated ranking map.

In some aspects, the methods, apparatuses, and computer-readable media described above can further generate, based on the refined saliency map, an edited output image having an effect applied to at least a portion of a background region of the image.

In some cases, the apparatuses described above can include a mobile phone, an image sensor, a smart wearable device, and/or a camera.

This summary is not intended to identify key or essential features of the claimed subject matter and is not intended to be used in isolation to determine the scope of the claimed subject matter. The subject matter should be understood by reference to appropriate portions of the entire specification of this disclosure, the drawings, and the claims.

The preceding, together with other features and embodiments, will become more apparent upon referring to the following specification, claims, and accompanying drawings.

### BRIEF DESCRIPTION OF THE DRAWINGS

To describe how the above-recited and other advantages and features of the disclosure can be obtained, a more particular description of the principles described above will be rendered by reference to specific embodiments thereof which are illustrated in the appended drawings. Understanding that these drawings depict only example embodiments of the disclosure and are not to be considered to limit its scope, the principles herein are described and explained with additional specificity and detail through the use of the drawings in which:

FIG. 1 is a block diagram illustrating an example image processing system, by some examples;

FIG. 2A is a flowchart illustrating an example process for generating an image processing effect, by some examples;

FIG. 2B is a flowchart illustrating another example process for generating an image processing effect, by some examples;

FIG. 3 is a diagram illustrating an example visual representations of inputs and outputs from the example process shown in FIG. 2A;

FIG. 4 is a diagram illustrating an example visual representations of inputs and outputs from the example process shown in FIG. 2B;

FIG. 5 illustrates an example configuration of a neural network for performing various image processing tasks, by some examples;

FIG. 6 illustrates an example process for extracting features from an image using a neural network, by some examples;

FIG. 7 illustrates an example method for generating image processing effects, by some examples; and

FIG. 8 illustrates an example computing device, by some examples.

### DETAILED DESCRIPTION

Certain aspects and embodiments of this disclosure are provided below. Some of these aspects and embodiments may be applied independently, and some may be applied in combination as would be apparent to those of skill in the art. In the following description, for explanation, specific details are outlined in order to provide a thorough understanding of embodiments of the application. However, it will be apparent that various embodiments may be practiced without these specific details. The figures and description are not intended to be restrictive.

The ensuing description provides example embodiments and features only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as outlined in the appended claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or any example term. Likewise, the disclosure is not limited to various embodiments given in this specification.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored, and that does not include carrier waves and/or transitory electronic signals propagating wirelessly or over wired connections. Examples of a non-transitory medium may include but are not limited to, a magnetic disk or tape, optical storage media such as compact disk (CD) or versatile digital disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

As previously noted, cameras are increasingly being equipped with capabilities for performing various image processing tasks and generating various image effects. Many of image processing tasks and effects, such as chroma keying, depth-of-field or “bokeh” effects, recognition tasks (e.g., object, face, and biometric recognition), feature extraction, machine vision, computer graphics, medical imaging, etc., rely on image segmentation procedures that divide an image into multiple segments which can be analyzed or processed to perform the desired image processing tasks or generate the desired image effects. For example, cameras are commonly equipped with a portrait mode function that enables shallow depth-of-field effects. A depth-of-field effect can bring a specific image region or object into focus, such as a foreground object or region, while blurring other regions or pixels in the image, such as background regions or pixels. The depth-of-field effect can be created using image segmentation techniques to identify and modify different regions or objects in the image, such as background and foreground regions or objects. In some examples, the depth-of-field effect can be created with the aid of depth information associated with the image.

One example approach for inferring depth and/or segmenting an image can be done by using a disparity map, which identifies the apparent pixel difference or motion between a pair of stereo images acquired by absorbing the left and right-sided lights from spatially aligned image sensors. Block matching can then be performed to measure pixel or sub-pixel disparities. Typically, objects that are close to the image sensor will appear to jump a significant distance while objects further away from the image sensor will appear to move very little. Such motion can represent the disparity. However, the disparity information in many cases, can be coarse and lacking in details, particularly in single lens camera applications, leading to poor quality depth-of-field effects.

On the other hand, salient object detection is a technique that can be implemented to detect objects that visually stand out. Such salient object detection can be performed in real time (or near real time) and an unsupervised manner. However, the unsupervised nature of salient object detection favors identifying objects that satisfy predefined criteria, such as objects with high contrast, objects near an image center or objects with fewer boundary connections. Thus, the detected object is often not the object that the user intends to bring into focus.

In many cases, the information from the disparity map and the saliency detection can complement each other to produce better image segmentation results. Thus, in some examples, the approaches herein can leverage the benefits of disparity-based depth estimation and salient object detection, while avoiding or reducing their respective shortcomings to produce high quality segmentation results, which can be used to generate improved image processing tasks and effects such as, for example and without limitation, depth-of-field effects with pixel-wise accuracy, chroma keying effects, computer graphic effects, image recognition tasks, feature extraction tasks, machine vision, and so forth. The approaches herein can, therefore, bridge (or implement) the two concepts (disparity and saliency) together to yield better image processing results.

For example, in some implementations, an image can be analyzed to extract features in the image, such as color or semantic features. The extracted features can be used to construct a Laplacian matrix. The Laplacian matrix, the extracted features, and the pixels (or superpixels) in the image can be used to perform soft object segmentation (e.g., salient object detection). The soft object segmentation can be based on a relevance between foreground queries and pixels (or superpixels) and/or features in the image. The foreground queries can be derived using a disparity map, a spatial prior map, and pixels (or superpixels) in the image. The relevance between the foreground queries and the pixels (or superpixels) and/or features in the image can be estimated using graph-based manifold ranking. After the soft object segmentation, a progressive scheme can be carried out to refine the segmentation result to achieve pixel-level accuracy.

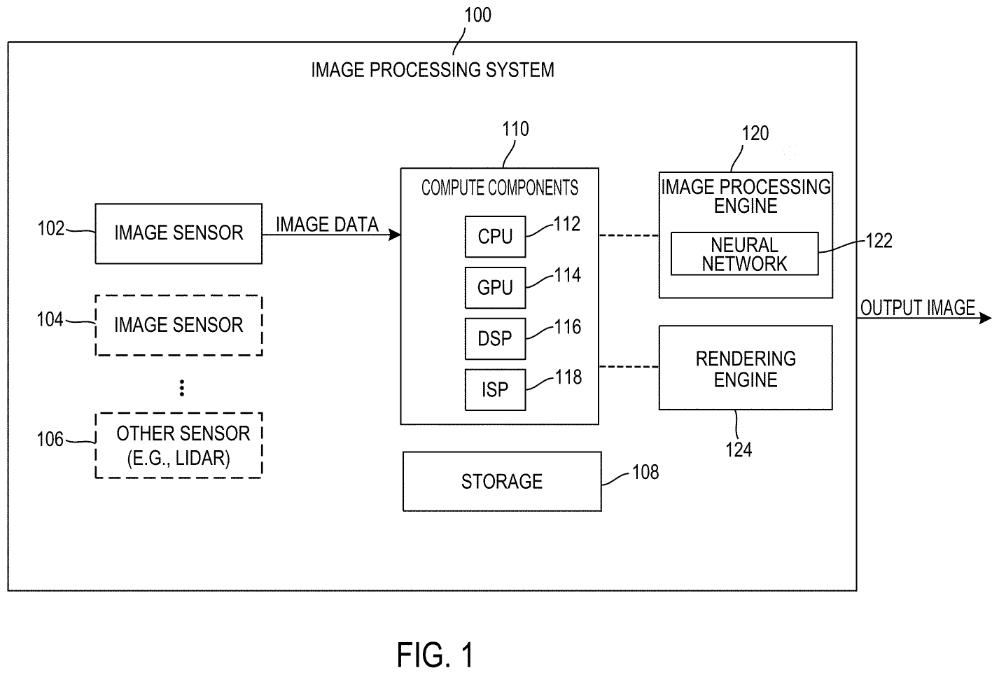

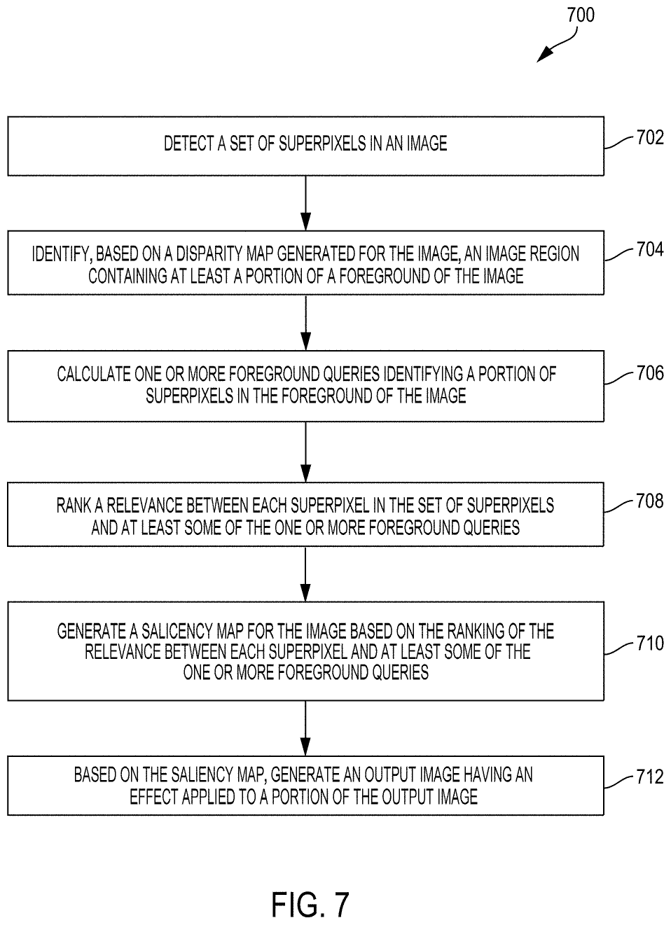

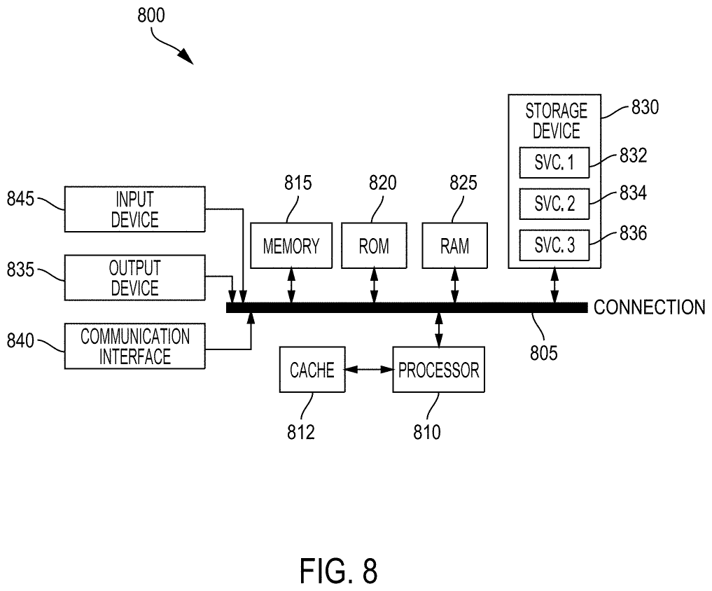

In the following disclosure, systems, methods, and computer-readable media are provided for generating image processing effects. The present technologies will be described in the following disclosure as follows. The discussion begins with a description of example systems, technologies and techniques for generating image processing effects, as illustrated in FIGS. 1 through 6. A description of an example method for generating image processing effects, as illustrated in FIG. 7, will then follow. The discussion concludes with a description of an example computing device architecture, including example hardware components suitable for generating images with depth-of-field effects, as illustrated in FIG. 8. The disclosure now turns to FIG. 1

FIG. 1 is a diagram illustrating an example image processing system 100. The image processing system 100 can perform various image processing tasks and generate various image processing effects as described herein. For example, the image processing system 100 can generate shallow depth-of-field images, generate chroma keying effects, perform feature extraction tasks, perform various image recognition tasks, implement machine vision, and/or perform any other image processing tasks. In some illustrative examples, the image processing system 100 can generate depth-of-field images from one or more image capturing devices (e.g., cameras, image sensors, etc.). For example, in some implementations, the image processing system 100 can generate a depth-of-field image from a single image capturing device, such as a single camera or image sensor device. While a depth-of-field effect is used herein as an illustrative example, the techniques described herein can be used for any image processing effect, such as chroma keying effects, one or more feature extraction effects, one or more image recognition effects, one or more machine vision effects, any combination thereof, and/or for any other image processing effects.

In the example shown in FIG. 1, the image processing system 100 includes an image sensor 102, a storage 108, compute components 110, an image processing engine 120, a neural network 122, and a rendering engine 124. The image processing system 100 can also optionally includes another image sensor 104 and one or more other sensors 106, such as light detection and ranging (LIDAR) sensing device. For example, in dual camera or image sensor applications, the image processing system 100 can include front and rear image sensors (e.g., 102, 104).

The image processing system 100 can be part of a computing device or multiple computing devices. In some examples, the image processing system 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, a laptop or notebook computer, a tablet computer, a set-top box, a television, a display device, a digital media player, a gaming console, a video streaming device, a drone, a computer in a car, an IoT (Internet-of-Things) device, or any other suitable electronic device(s).

In some implementations, the image sensor 102, the image sensor 104, the other sensor 106, the storage 108, the compute components 110, the image processing engine 120, the neural network 122, and the rendering engine 124 can be part of the same computing device. For example, in some cases, the image sensor 102, the image sensor 104, the other sensor 106, the storage 108, the compute components 110, the image processing engine 120, the neural network 122, and the rendering engine 124 can be integrated into a smartphone, laptop, tablet computer, smart wearable device, gaming system, and/or any other computing device. However, in some implementations, the image sensor 102, the image sensor 104, the other sensor 106, the storage 108, the compute components 110, the image processing engine 120, the neural network 122, and/or the rendering engine 124 can be part of two or more separate computing devices.

The image sensors 102 and 104 can be any image and/or video sensors or capturing devices, such as a digital camera sensor, a video camera sensor, a smartphone camera sensor, an image/video capture device on an electronic apparatus such as a television or computer, a camera, etc. In some cases, the image sensors 102 and 104 can be part of a camera or computing device such as a digital camera, a video camera, an IP camera, a smartphone, a smart television, a game system, etc. In some examples, the image sensor 102 can be a rear image capturing device (e.g., a camera, video, and/or image sensor on a back or rear of a device) and the image sensor 104 can be a front image capturing device (e.g., a camera, image, and/or video sensor on a front of a device). In some examples, the image sensors 102 and 104 can be part of a dual-camera assembly. The image sensors 102 and 104 can capture the image and/or video content (e.g., raw image and/or video data), which can then be processed by the compute components 110, the image processing engine 120, the neural network 122, and/or the rendering engine 124 as described herein.

The other sensor 106 can be any sensor for detecting and measuring information such as distance, motion, position, depth, speed, etc. Non-limiting examples of sensors include LIDARs, gyroscopes, accelerometers, and magnetometers. In one illustrative example, the sensor 106 can be a LIDAR configured to sense or measure distance and/or depth information which can be used to calculate depth-of-field effects as described herein. In some cases, the image processing system 100 can include other sensors, such as a machine vision sensor, a smart scene sensor, a speech recognition sensor, an impact sensor, a position sensor, a tilt sensor, a light sensor, etc.

The storage 108 can be any storage device(s) for storing data, such as image or video data for example. Moreover, the storage 108 can store data from any of the components of the image processing system 100. For example, the storage 108 can store data or measurements from any of the sensors 102, 104, 106, data from the compute components 110 (e.g., processing parameters, output images, calculation results, etc.), and/or data from any of the image processing engine 120, the neural network 122, and/or the rendering engine 124 (e.g., output images, processing results, etc.). In some examples, the storage 108 can include a buffer for storing data (e.g., image data) for processing by the compute components 110.

In some implementations, the compute components 110 can include a central processing unit (CPU) 112, a graphics processing unit (GPU) 114, a digital signal processor (DSP) 116, and an image signal processor (ISP) 118. The compute components 110 can perform various operations such as image enhancement, object or image segmentation, computer vision, graphics rendering, augmented reality, image/video processing, sensor processing, recognition (e.g., text recognition, object recognition, feature recognition, tracking or pattern recognition, scene change recognition, etc.), disparity detection, machine learning, filtering, depth-of-field effect calculations or renderings, and any of the various operations described herein. In some examples, the compute components 110 can implement the image processing engine 120, the neural network 122, and the rendering engine 124. In other examples, the compute components 110 can also implement one or more other processing engines.

Moreover, the operations for the image processing engine 120, the neural network 122, and the rendering engine 124 can be implemented by one or more of the compute components 110. In one illustrative example, the image processing engine 120 and the neural network 122 (and associated operations) can be implemented by the CPU 112, the DSP 116, and/or the ISP 118, and the rendering engine 120 (and associated operations) can be implemented by the GPU 114. In some cases, the compute components 110 can include other electronic circuits or hardware, computer software, firmware, or any combination thereof, to perform any of the various operations described herein.

In some cases, the compute components 110 can receive data (e.g., image data, video data, etc.) captured by the image sensor 102 and/or the image sensor 104, and process the data to generate output images or frames having a depth-of-field effect. For example, the compute components 110 can receive image data (e.g., one or more frames, etc.) captured by the image sensor 102, detect or extract features and information (e.g., color information, texture information, semantic information, etc.) from the image data, calculate disparity and saliency information, perform background and foreground object segmentation, and generate an output image or frame having a depth-of-field effect. An image or frame can be a red-green-blue (RGB) image or frame having red, green, and blue color components per pixel; a luma, chroma-red, chroma-blue (YCbCr) image or frame having a luma component and two chroma (color) components (chroma-red and chroma-blue) per pixel; or any other suitable type of color or monochrome picture.

The compute components 110 can implement the image processing engine 120 and the neural network 122 to perform various image processing operations and generate a depth-of-field image effect. For example, the compute components 110 can implement the image processing engine 120 and the neural network 122 to perform feature extraction, superpixel detection, disparity mapping, spatial mapping, saliency detection, blurring, segmentation, filtering, color correction, noise reduction, scaling, ranking, etc. The compute components 110 can process image data captured by the image sensors 102 and/or 104; image data in storage 108; image data received from a remote source, such as a remote camera, a server or a content provider; image data obtained from a combination of sources; etc.

In some examples, the compute components 110 can segment objects in an image by distilling foreground cues from the image sensor 102, and generate an output image with a depth-of-field effect. In some cases, the compute components 110 can use spatial information (e.g., a spatial prior map) and disparity information (e.g., a disparity map) to segment objects in an image and generate an output image with a depth-of-field effect. In other cases, the compute components 110 can also, or use other information such as face detection information. In some cases, the compute components 110 can determine the disparity map or information from the image sensor (e.g., from autofocus information at the image sensor). In other cases, the compute components 110 can determine the disparity map or information in other ways. For example, the compute components 110 can leverage a second image sensor (e.g., 104) in a dual image sensor implementation with stereo vision techniques, or a LIDAR sensor (e.g., 106), to determine disparity map and depth information for an image.

In some examples, the compute components 110 can perform foreground-background segmentation at (or nearly at) pixel-level accuracy, to generate an output image with a depth-of-field or bokeh effect even in single camera or image sensor implementations, such as mobile phones having a single camera or image sensor. The foreground-background segmentation can enable (or be used in conjunction with) other image adjustments or image processing operations such as, for example, and without limitation, depth-enhanced and object-aware auto exposure, auto white balance, auto-focus, tone mapping, etc.

While the image processing system 100 is shown to include certain components, one of ordinary skill will appreciate that the image processing system 100 can include more or fewer components than those shown in FIG. 1. For example, the image processing system 100 can also include, in some instances, one or more memory devices (e.g., RAM, ROM, cache, and/or the like), one or more networking interfaces (e.g., wired and/or wireless communications interfaces and the like), one or more display devices, and/or other hardware or processing devices that are not shown in FIG. 1. An illustrative example of a computing device and hardware components that can be implemented with the image processing system 100 is described below with respect to FIG. 8.

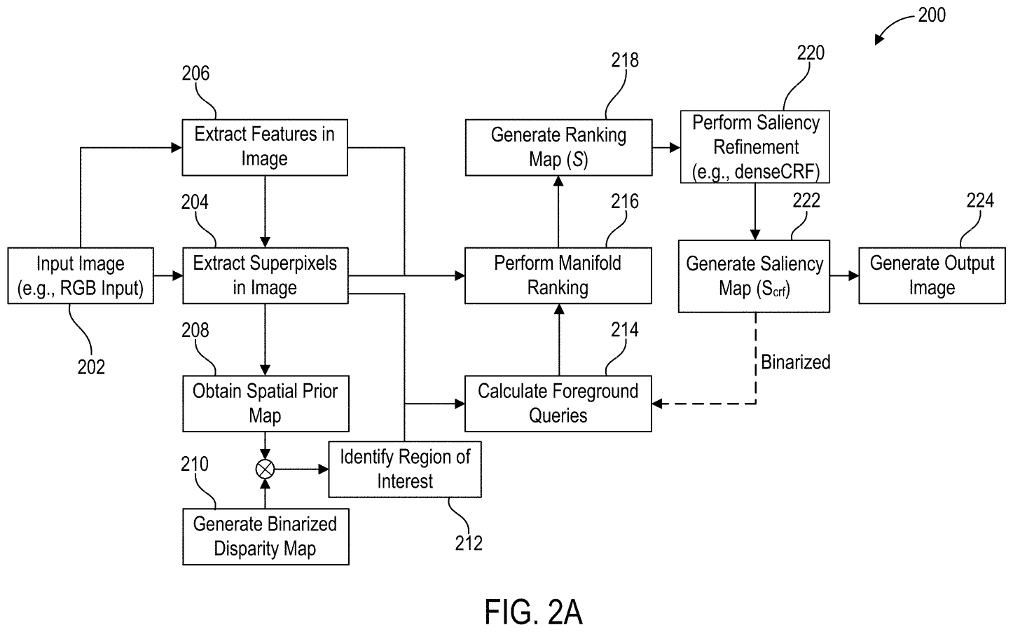

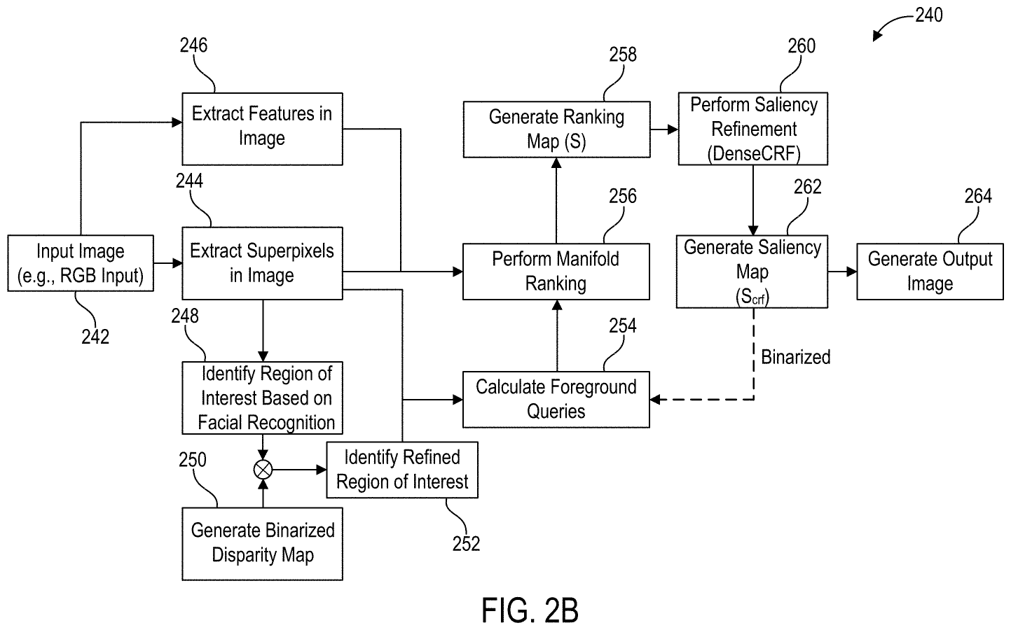

FIG. 2A is a flowchart illustrating an example process 200 for generating an image processing effect. In this example, the image processing effect generated by process 200 can be a depth-of-field effect. However, it should be noted that the depth-of-field effect is used herein as an example effect provided for explanation purposes. One of ordinary skill in the art will recognize that the techniques described in process 200 below can be applied to perform other image processing tasks and generate other image processing effects such as, for example and without limitation, chroma key compositing, feature extraction, recognition tasks (e.g., object and face recognition), machine vision, medical imaging, etc.

At block 202, the image processing system 100 can receive an input image (e.g., an RGB image) for processing. The image processing system 100 can receive the input image from an image sensor (102), for example.

At block 204, the image processing system 100 can determine (e.g., via image processing engine 120 and/or neural network 122) superpixels in the image. For example, the image processing system 100 can segment or partition the image into multiple superpixels. In some implementations, the image processing system 100 can extract the superpixels in the image using a superpixel segmentation algorithm, such as a simple linear iterative clustering (SLIC) algorithm which can perform local clustering of pixels. The superpixel extraction or detection can help preserve image structures while abstracting unnecessary details, and the superpixels can serve as the computational unit for ranking as described below at block 216.

The superpixels can represent different segments or regions of the image and can include groups of pixels in the image. For example, a superpixel can include a group of homogeneous or nearly homogeneous pixels in the image and/or a group of pixels having one or more characteristics such that when the superpixel is rendered, the superpixel can have one or more uniform or consistent characteristics such as color, texture, brightness, semantics, etc. Thus, in some examples, superpixels can provide a perceptual grouping of pixels in the image.

Moreover, the homogeneous or nearly homogeneous pixels referenced above can include pixels that are consistent, uniform, or significantly similar in texture, color, brightness, semantics, and/or any other characteristic(s). In some implementations, while objects in an image may be divided into multiple superpixels, a specific superpixel may not be divided by an object's boundary. Further, in some implementations, some or all of the pixels in a superpixel can be spatially related (e.g., spatially contiguous). For example, the pixels in a superpixel can include neighboring or adjacent pixels from the image.

At block 206, the image processing system 100 can detect (e.g., via image processing engine 120 and/or neural network 122) features in the image. For example, the image processing system 100 can analyze the image and extract feature information from each superpixel in the image. In some implementations, the image processing system 100 can extract features in the image or superpixels in the image using a neural network, such as a convolutional neural network. Moreover, the features detected in the image can include color information (e.g., color components or channels), texture information, semantic information, etc. The semantic information or features can include, for example and without limitation, visual contents of the image such as objects present in the image, a scene in the image, a context related to the image, a concept related to the image, etc.

In some implementations, when extracting or detecting color features, the image processing system 100 can record each pixel in a particular color space (e.g., CIE L*a*b*) to a three-dimensional (3D) vector. Further, when extracting or detecting semantic features, the image processing system 100 can extract and combine the result from a convolutional neural network at mid-level and high-level stages. The image processing system 100 can also use principal component analysis (PCA) to reduce the original dimensional vectors associated with the semantic features to 3D vectors and normalize them to use 0 or 1 values (e.g., [0, 1]). As previously noted, the semantic features in this example are generated by a convolutional neural network, which can be pre-trained. However, as one of skill in the art will recognize, other implementations may use any other feature extraction method. Indeed, the convolutional neural network and algorithm in this example are provided as a non-limiting, illustrative example for explanation purposes.

At block 208, the image processing system 100 can obtain a spatial prior map for the image based on the superpixels determined at block 204. The spatial prior map can include spatial prior information and can represent the probability or likelihood that one or more objects are located in a center region of the image as opposed to a border region(s) of the image.

At block 210, the image processing system 100 can generate a binarized disparity map associated with the image. In some examples, the image processing system 100 can obtain a disparity map or “depth map” for the image and binarize the disparity map to include disparity values of 0 or 1 (e.g., [0, 1]). The disparity map can represent apparent pixel differences, motion, or depth (the disparity). Typically, objects that are close to the image sensor that captured the image will have greater separation or motion (e.g., will appear to move a significant distance) while objects that are further away will have less separation or motion. Such separation or motion can be captured by the disparity values in the disparity map. Thus, the disparity map can provide an indication of which objects are likely within a region of interest (e.g., the foreground), and which are likely not within the region of interest.

In some cases, the disparity information for the disparity map can be obtained from hardware (e.g., an image sensor or camera device). For example, the disparity map can be generated using auto-focus information obtained from a hardware device (e.g., image sensor, camera, etc.) used to produce the image. The auto-focus information can help identify where a target or object of interest (e.g., a foreground object) is likely to be in the field of view (FOV). To illustrate, an auto-focus function can be leveraged to help the image processing system 100 identify where the target or object of interest is likely to be in the FOV. In some examples, an auto-focus function on hardware can automatically adjust a lens setting to set the optical focal points on the target or object of interest. When the image processing system 100 then checks the disparity map containing the disparity information, the scene behind the target or object of interest can have a negative disparity value, while the scene before the target or object of interest can have a positive disparity value and areas around the target or object of interest can contain a disparity value closer to zero.

The image processing system 100 can thus generate the binarized disparity map based on the disparity map and a threshold such as, for example, [−delta, delta] with delta being a small positive value for screening. For example, for a region with a disparity value in the [−delta, delta] range, the image processing system 100 can assign the region a value of 1, and zero otherwise. The value of 1 in the binarized disparity map can indicate the focused area (e.g., the region(s) where the target or object of interest may appear).

In some example, dual image sensor or camera implementations, the disparity information can be derived using stereo vision or LIDAR techniques. Moreover, in some implementations, such as a single camera or monocular camera implementations, the disparity information can be derived using phase detection (PD). For example, the disparity can be derived from PD pixels.

At block 212, the image processing system 100 can modify the spatial prior map with the binarized disparity map to identify a region of interest in the image. The region of interest can include a region estimated to represent or contain at least a portion of the foreground of the image. Moreover, by modifying the spatial prior map with the binarized disparity map, the image processing system, 100 can generate a refined region of interest, which can be used later to identify foreground queries as described herein.

For example, in some cases, the spatial prior map can be used to enhance the binarized disparity map by integrating the center prior to each superpixel vᵢ based on the distance of the superpixel's averaged x-y coordinates coord(vᵢ) to the image center 0. The rationale in this example can be that foreground objects are more likely to be placed around the image center. Thus, to illustrate, considering the spatial prior for the image, the value of each superpixel vᵢ can be computed as follows:

$$SP ( {v}_{i} ) = exp ( - {‖ coord ( {v}_{i} ) - O ‖}_{2}^{2} ) . \qquad Equation ( 1 )$$

The spatial prior map SP can then be normalized to [0, 1] before multiplying it with the binarized disparity map to generate an initial estimate of the auto-focus area in the image. The estimated area or “region of interest” can be treated as an initial saliency map, and can be used to facilitate the selection of superpixel vᵢ as a foreground query.

At block 214, the image processing system 100 can calculate foreground queries based on the region of interest identified at block 212 and the superpixels determined at block 204. The foreground queries can indicate which superpixels are estimated to belong to the foreground. In some examples, to calculate the foreground queries, the image processing system 100 can calculate mean saliency values for the superpixels in the image, rank the mean saliency values, and select as the foreground queries one or more superpixels having the highest mean saliency values or having the top n mean saliency values, where n is a percentage of all mean saliency values associated with all the superpixels in the region of interest.

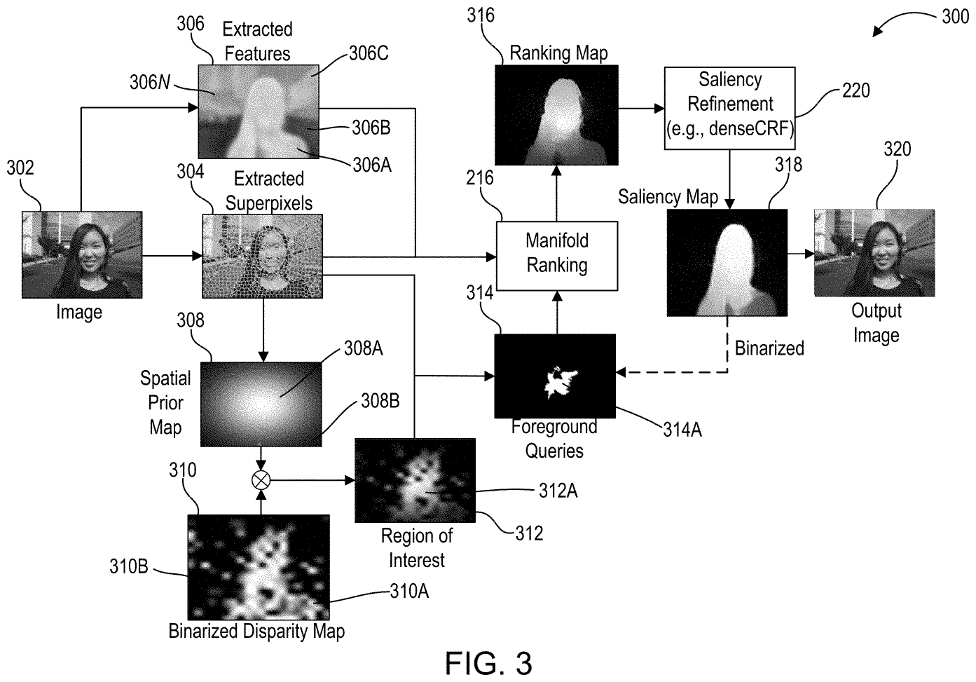

To illustrate, in some examples, the location of the region of interest (e.g., the target or object that the user wants to separate from the background) in the image can be represented or illustrated using a probability map as shown below in item 312 of FIG. 3. The probability map can contain a probability of each pixel belonging to the target or object to be separated from the background. In some cases, the probability can also be expressed as or include a saliency, which can represent the likelihood of where the user's attention is within the image. The image processing system 100 can use the probability map to calculate the mean value of pixels inside each superpixel region. Since there are n number of superpixels in the image, this calculation can result in an array with n number of values (e.g., the mean values of the n number of superpixels). After obtaining the n number of values for the superpixels in the image, the image processing system 100 can apply a sorting algorithm to this array of values to identify the superpixels with higher values. The image processing system 100 can then identify the superpixels with higher values as the foreground queries.

At block 216, the image processing system 100 can use the foreground queries, the superpixels, and the detected features to perform manifold ranking. The manifold ranking can rank the relevance between each superpixel and the foreground queries. The manifold ranking can have a closed form, thus enabling efficient computation.

In some examples, the image processing system 100 can use the superpixels derived at block 204 and the features derived at block 206 to construct a graph used with the foreground queries to generate a manifold ranking result. For example, in some cases, the image processing system 100 can construct a graph [symbol] =(ν, ε), where ν and ε respectively represent vertices and edges in the image. In graph [symbol] , each vertex vᵢ ∈ν can be defined to be a superpixel. The edge eᵢⱼ ∈ε₁ can be added if superpixels vᵢ and vⱼ are spatially connected in an image, and weighted based on the feature distance calculated for superpixels vᵢ and vⱼ. In some examples, the edge weight can be determined by the feature distance or similarity calculated for superpixels vᵢ and vⱼ as follows:

$${a}_{ij} = exp ( - \frac{d ( {p}_{i} , {p}_{j} )}{{σ}_{c}} - γ \frac{d ( {q}_{i} , {q}_{j} )}{{σ}_{s}} ) , \qquad Equation ( 2 )$$

where pᵢ and qⱼ respectively denote the averaged color and semantic representations of pixels in the superpixel vᵢ, pⱼ and qⱼ respectively denote the averaged color and semantic representations of pixels in the superpixel vⱼ, d( ) is the χ² feature distance, and γ represents a weight applied to the semantic features.

In the example Equation (2), the value of constant σ_{c} can be set to the average pair-wise distance between all superpixels under their color features, and the value of σₛ can be similarly set to the average pair-wise distance between all superpixels under their semantic features. It should be noted that the color and semantic features are non-limiting examples provided here for explanation purposes, and other implementations may utilize more, less, or different types of features. For example, in some cases, Equation (2) can be implemented using only one type of features such as color or semantic features, or a different combination of features such as color, semantic, and/or texture features.

In some cases, the image processing system 100 can also construct a Laplacian matrix L ∈ [symbol] ^{N×N} of graph [symbol] with affinty matrix A=[aᵢⱼ]N×N, where N denotes the total number of superpixels in the image. Moreover, in some implementations, the image processing system 100 can infer labels for nodes (e.g., superpixels) on the graph and use the graph labeling on the manifold structure of data (e.g., the image). In a given a dataset X=[x₁, . . . , xₗ,xₗ₊₁,·,x_{N}] ∈ [symbol] ^{M×N}, where M denotes the feature dimensions of each data point, some data points can be labeled queries and the rest can be ranked according to their relevance to the queries.

For example, let f:XΔ[0,1] be a ranking function assigning value fᵢ to each data point xᵢ, where 0 is a background data point value and 1 is a foreground data point value. Here, ƒ can be viewed as a vector ƒ=[ƒ₁, . . . , f_{N}]^{T}. Moreover, let [symbol] =[ [symbol] ₁, [symbol] ₂, . . . , [symbol] _{N}]^{T} denote an indication vector, in which [symbol] ᵢ=1 if χᵢ is a query and [symbol] ᵢ=0 otherwise. Given graph [symbol] , a degree matrix can be D=deg{d₁₁, . . . , dₙₙ} where dᵢᵢ=Σⱼaᵢⱼ and μ is a weighting constant. In this example, the optimal ranking of queries can then be computed by solving the following minimization or optimization problem:

$${f}^{*} = arg {min}_{f} \frac{1}{2} ( {\sum }_{i , j = 1}^{N} {a}_{i j} {‖ \frac{{f}_{i}}{\sqrt{{d}_{ii}}} - \frac{{f}_{i}}{\sqrt{{d}_{ii}}} ‖}^{2} + μ {\sum }_{i = 1}^{N} {‖ {f}_{i} - {𝒴}_{i} ‖}^{2} ) . \qquad Equation ( 3 )$$

Solving Equation (3) above can help ensure that similar data points are assigned similar ranking values, while keeping the ranked result close to the original indication vector [symbol] . The minimum solution can be computed by setting the derivative of Equation (3) to zero. The closed form solution of the ranking function can be expressed as follows:

f*=(D−αA)⁻¹y Equation (4).

Once the foreground queries are calculated, the indicator vector [symbol] is formed and used to compute the ranking vector ƒ* using Equation (4). At block 218, the image processing system 100 can then generate a ranking map S. In some cases, the image processing system 100 can use the ranking vector ƒ* to generate the ranking map S. In some examples, the image processing system 10,0 can normalize the ranking vector ƒ* between the range of 0 and 1 to form the ranking map S. The ranking map S can, for example, represent or convey a saliency ranking of superpixels in the image.

At block 220, the image processing system 100 can perform a saliency refinement for the ranking map S. The saliency refinement can be used to improve spatial coherence, for example. In some cases, the saliency refinement can be performed using a pixel-wise saliency refinement model. For example, in some implementations, the saliency refinement can be performed based on a fully connected conditional random field (CRM) or denseCRF.

To illustrate, for an image having of n pixels, L=[l₁, . . . , lₙ] can denote a binary labeling of pixels, where 1 can be used to represent a salient pixel and zero can be used otherwise. This model can solve a binary pixel labeling problem by employing the following energy equation:

E(L)=−Σᵢ log(P(lᵢ))+Σ_{i,j}θ_{i,j}(lᵢ, lⱼ) Equation (5),

where P(lᵢ) is the probability of a pixel xᵢ having label lᵢ, which indicates a likelihood of pixel i being salient.

Initially, P(1)=Sᵢ and P(0)=1−Sᵢ, where Sᵢ is the saliency score at pixel i from the ranking map S. Moreover, θᵢᵢ(lᵢ, lⱼ) can be a pairwise potential defined as follows:

$${θ}_{ij} = δ ( {l}_{i} \neq {l}_{j} ) [ {w}_{1} exp ( - \frac{{‖ {p}_{i} - {p}_{j} ‖}^{2}}{2 {σ}_{c}^{2}} - \frac{‖ coord ( {v}_{i} ) - {coord ( {v}_{i} )}^{2} ‖}{2 {σ}_{β}^{2}} ) + {w}_{2} exp ( - \frac{{‖ {q}_{i} - {q}_{j} ‖}^{2}}{2 {σ}_{s}^{2}} - \frac{‖ coord ( {v}_{i} ) - {coord ( {v}_{i} )}^{2} ‖}{2 {σ}_{β}^{2}} ) ] . \qquad Equation ( 6 )$$

The above kernel can help or influence nearby pixels with similar features (e.g., color (pᵢ) and semantic (qᵢ) features) to take similar saliency scores.

At block 222, the image processing system 100 can generate a saliency map (S_{crf}). The saliency map (S_{crf}) can be generated based on the saliency refinement of the ranking map S at block 220. In some examples, the image processing system 100 can generate the saliency map (S_{crf}) using the respective probability of each pixel being salient, which can be determined based on the refined ranking map S.

At block 224, the image processing system 100 can generate an output image based on the saliency map (S_{crf}). The output image can include an image processing effect, such as a depth-of-field or bokeh effect, generated based on the saliency map (S_{crf}). The image processing effect can include, for example and without limitation, a stylistic effect, an artistic effect, a computational photography effect, a depth-of-field or bokeh effect, a chroma keying effect, an image recognition effect, a machine vision effect, etc. The saliency map (S_{crf}) used to generate the output image can produce smooth results with pixel-wise accuracy, and can preserve salient object contours.

In some cases, after generating the saliency map (S_{crf}) at block 222, instead of proceeding to block 224 to generate the output image, the image processing system 100 can binarize the saliency map (S_{crf}) and use the binarized saliency map (S_{crf}) to perform an iterative refinement process to achieve progressive improvements in quality or accuracy. In the iterative refinement process, the image processing system 100 can perform the steps from blocks 214 through 222 in one or more iterations or rounds until, for example, a specific or desired result is obtained. Thus, instead of proceeding to block 224 after block 222, in some cases, the image processing system 100 can proceed back to block 214 to start another iteration of blocks 214 through 222. After block 222, the image processing system 100 can again proceed to block 224 or back to block 214 for another iteration of blocks 214 through 222.

For example, the image processing system 100 can use the binarized saliency map (S_{crf}) to calculate new, refined, or updated foreground queries at block 214. The image processing system 100 can use the new, refined, or updated foreground queries at block 216, to perform manifold ranking as previously described. At block 218, the image processing system 100 can then generate a new, refined, or updated ranking map S based on the manifold ranking results from block 216. The image processing system 100 can also perform saliency refinement at block 220, and generate a new, refined, or updated saliency map (S_{crf}) at block 222. The image processing system 100 can then use the new, refined, or updated saliency map (S_{crf}) to generate the output image at block 224; or use a binarized version of the new, refined, or updated saliency map (S_{crf}) to perform another iteration of the steps in blocks 214 through 222 as previously described.

In some cases, when performing another iteration of blocks 214 through 222, the binarized version of the saliency map (S_{crf}) generated at block 222 can help improve the quality or accuracy of the foreground queries calculated at block 214. This in turn can also help improve the quality or accuracy of the results or calculations at blocks 216 through 222. Thus, in some cases, the additional iteration(s) of blocks 214 through 222 can produce a saliency map (S_{crf}) of progressively higher quality or accuracy, which can be used to generate an output image of higher quality or accuracy (e.g., better field-of-view effect, etc.) at block 224.

FIG. 2B is a flowchart illustrating another example process 240 for generating an image processing effect. In this example, the image processing effect generated by process 240 can be a depth-of-field effect. However, it should be noted that the depth-of-field effect is used herein as an example effect provided for explanation purposes. One of ordinary skill in the art will recognize that the techniques described in process 240 below can be applied to perform other image processing tasks and generate other image processing effects such as, for example and without limitation, chroma key compositing, feature extraction, recognition tasks (e.g., object and face recognition), machine vision, medical imaging, etc.

At block 242, the image processing system 100 can first receive an input image (e.g., an RGB image). At block 244, the image processing system 100 can determine (e.g., via image processing engine 120 and/or neural network 122) superpixels in the image and, at block 246, the image processing system 100 can detect (e.g., via image processing engine 120 and/or neural network 122) features in the image. The image processing system 100 can determine the superpixels and features as previously described with respect to blocks 204 and 206 in FIG. 2A.

At block 248, the image processing system 100 can identify a region of interest in the image using facial recognition. The region of interest can include a region estimated to represent or contain at least a portion of the foreground of the image. In some examples, the region of interest can be a bounding box containing at least a portion of a face detected in the image.

Moreover, in the example process 240, the region of interest identified at block 248 can be implemented in lieu of the spatial prior map implemented at block 208 of process 200 shown in FIG. 2A. However, in other cases, the region of interest can be used in addition to the spatial prior map previously described. For example, in some implementations, the region of interest identified at block 248 can be used to adjust the spatial prior map, which can then be used in blocks 250 and 252 described below or in blocks 210 and 212 of process 200 as previously described.

To illustrate, the region of interest can contain a bounding box identified using facial recognition as noted above. The bounding box here can be used to shift the center in the spatial prior map according to the center of the bounding box. The adjusted spatial prior map can then be used along with a binarized disparity map to identify a region of interest as described herein with respect to blocks 210-212 and blocks 250-252.

At block 250, the image processing system 100 can generate a binarized disparity map associated with the image. The image processing system 100 can generate the binarized disparity map as previously described with respect to block 210 in FIG. 2A.

At block 252, the image processing system 100 can modify the region of interest identified at block 248 with the binarized disparity map generated at block 250 to identify a refined region of interest in the image. The refined region of interest can include a region estimated to represent or contain at least a portion of the foreground of the image.

At block 254, the image processing system 100 can calculate foreground queries based on the refined region of interest identified at block 252 and the superpixels determined at block 244. The foreground queries can indicate which superpixels are estimated to belong to the foreground. In some examples, to calculate the foreground queries, the image processing system 100 can calculate mean saliency values for the superpixels in the image, rank the mean saliency values, and select one or more superpixels having the highest or top n (e.g., top 5%, 10%, etc.) mean saliency values as the foreground queries.

At block 256, the image processing system 100 can use the foreground queries, the superpixels, and the detected features to perform manifold ranking. At block 258, the image processing system 100 can generate a ranking map S based on the manifold ranking. The image processing system 100 can perform the manifold ranking and generate the ranking map S as previously described with respect to blocks 216 and 218 in FIG. 2A.

At block 260, the image processing system 100 can perform a saliency refinement for the ranking map S. The saliency refinement can be used to improve spatial coherence, for example. In some cases, the saliency refinement can performed using a pixel-wise saliency refinement model such as a denseCRF, as previously described.

At block 262, the image processing system 100 can generate a saliency map (S_{crf}). The saliency map (S_{crf}) can be generated based on the saliency refinement of the ranking map S at block 260.

At block 264, the image processing system 100 can generate an output image based on the saliency map (S_{crf}). The output image can include a depth-of-field or bokeh effect generated based on the saliency map (S_{crf}). The saliency map (S_{crf}) used to generate the output image can produce smooth results with pixel-wise accuracy, and can preserve salient object contours.

In some cases, after generating the saliency map (S_{crf}) at block 262, instead of proceeding to block 264 to generate the output image, the image processing system 100 can binarize the saliency map (S_{crf}) and use the binarized saliency map (S_{crf}) to perform an iterative refinement process to achieve progressive improvements in quality or accuracy. In the iterative refinement process, the image processing system 100 can perform the steps from blocks 254 through 262 in one or more iterations or rounds as previously described with respect to process 200.

FIG. 3 is a diagram 300 illustrating example visual representations of inputs and outputs from process 200 shown in FIG. 2A. In this example, block 302 depicts an example input image being processed according to process 200. Block 304 depicts a representation of superpixels extracted (e.g., at block 204 of process 200) from the input image, and block 306 depicts a representation of features extracted (e.g., at block 206 of process 200) from the input image. As illustrated here, block 306 includes semantic and color features 306A-N extracted or detected from the input image.

Block 308 depicts a spatial prior map generated for the superpixels extracted from the input image. The spatial prior map in this example depicts light regions 308A and darker regions 308B representing different spatial prior information or probabilities.

Block 310 depicts a binarized disparity map generated for the input image. As illustrated, the binarized disparity map includes light regions 310A and darker regions 310B plotting indications where a target or object of interest (e.g., a foreground region of interest) is or may be located.

Block 312 depicts a region of interest 312A identified after multiplying the spatial prior map depicted at block 308 with the binarized disparity map depicted at block 310. Block 314 depicts foreground queries 314A generated based on the extracted superpixels (block 304) and the region of interest 312A (block 312).

Block 316 depicts a ranking map generated based on the foreground queries 314A, the extracted superpixels (block 304) and the extracted features 306A-N. The ranking map depicts saliency detection result produced after performing manifold ranking (block 216) based on the foreground queries 314A, the extracted superpixels (block 304) and the extracted features 306A-N.

Block 318 depicts a saliency map representing refined saliency detection results produced by performing saliency refinement (block 220) for the ranking map. Finally, block 320 depicts an output image with depth-of-field effects generated based on the saliency map from block 318.

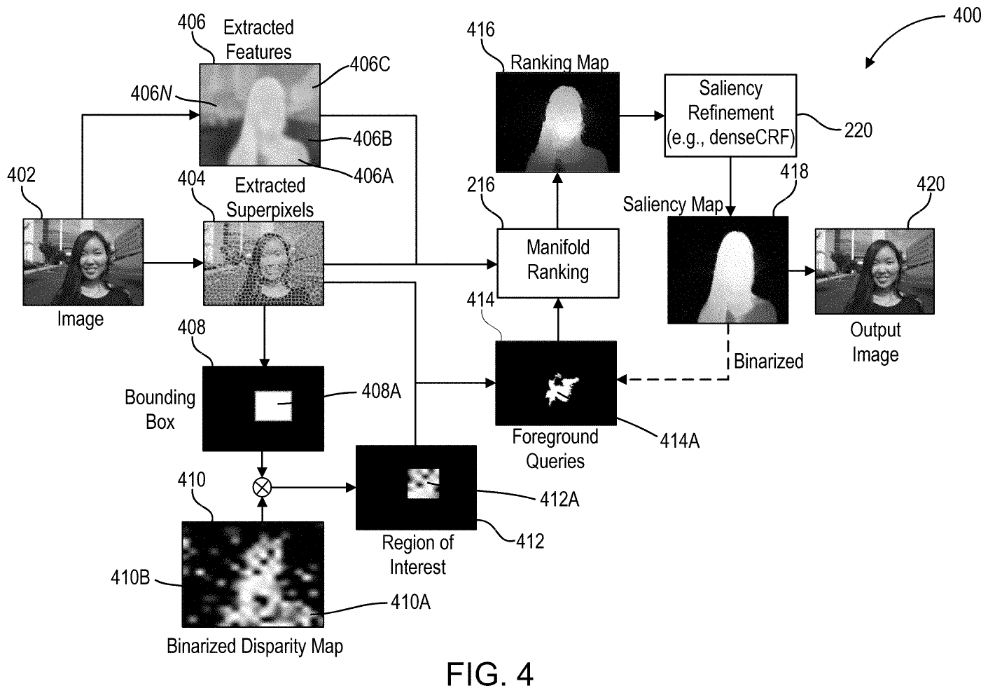

FIG. 4 is a diagram 400 illustrating example visual representations of inputs and outputs from process 240 shown in FIG. 2B. In this example, block 402 depicts an example input image being processed according to process 240. Block 404 depicts a representation of superpixels extracted (e.g., at block 244 of process 240) from the input image, and block 406 depicts a representation of features extracted (e.g., at block 246 of process 240) from the input image.

Block 408 depicts a bounding box 408A in a region of interest on the image. The bounding box 408A can be identified using face recognition as previously described. As illustrated, the bounding box 408A is at, or close to, the center of the image and covers at least a portion of the pixels associated with the face of a user depicted in the input image.

Block 410 depicts a binarized disparity map generated for the input image. As illustrated, the binarized disparity map includes light regions 410A and darker regions 410B which can plot indications where a target or object of interest (e.g., a foreground region of interest) is or may be located.

Block 412 depicts a region of interest 412A identified based on the bounding box 408A and the binarized disparity map depicted at block 310. Block 414 depicts the foreground queries 414A generated based on the extracted superpixels (block 404) and the region of interest 412A (block 412).

Block 416 depicts a ranking map generated based on the foreground queries 414A, the extracted superpixels (block 404) and the extracted features 406A-N. The ranking map depicts saliency detection result produced after performing manifold ranking (block 256) based on the foreground queries 414A, the extracted superpixels (block 404) and the extracted features 406A-N.

Block 418 depicts a saliency map representing refined saliency detection results produced by performing saliency refinement (block 260) for the ranking map. Finally, block 420 depicts an output image with depth-of-field effects generated based on the saliency map from block 418.

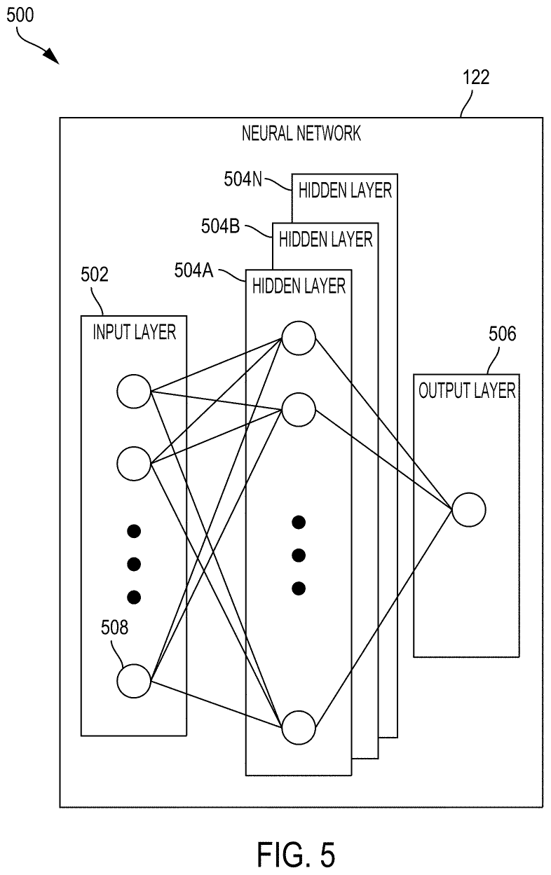

FIG. 5 illustrates an example of configuration 500 of the neural network 122. In some cases, the neural network 122 can be used by the image processing engine 120 in the image processing system 100 to detect (e.g., at blocks 206 or 246) features in an image, such as semantic features. In other cases, the neural network 122 can be implemented by the image processing engine 120 to perform other image processing tasks, such as segmentation and recognition tasks. For example, in some cases, the neural network 122 can be implemented to perform face recognition, background-foreground segmentation, superpixel segmentation, etc.

The neural network 122 includes an input layer 502, which includes input data. In one illustrative example, the input data at input layer 502 can include image data (e.g., input image 302 or 402).

The neural network 122 further includes multiple hidden layers 504A, 504B, through 504N (collectively “504” hereinafter). The neural network 122 can include “N” number of hidden layers (504), where “N” is an integer greater or equal to one. The number of hidden layers can include as many layers as needed for the given application.

The neural network 122 further includes an output layer 506 that provides an output resulting from the processing performed by the hidden layers 504. In one illustrative example, the output layer 506 can provide a feature extraction or detection result based on an input image. The extracted or detected features can include, for example and without limitation, color, texture, semantic features, etc.

The neural network 122 is a multi-layer neural network of interconnected nodes. Each node can represent a piece of information. Information associated with the nodes is shared among the different layers (502, 504, 506) and each layer retains information as it is processed. In some examples, the neural network 122 can be a feed-forward network, in which case there are no feedback connections where outputs of the network are fed back into itself. In other examples cases, the neural network 122 can be a recurrent neural network, which can have loops that allow information to be carried across nodes while reading in the input.

Information can be exchanged between nodes in the layers (502, 504, 506) through node-to-node interconnections between the layers (502, 504, 506). Nodes of the input layer 502 can activate a set of nodes in the first hidden layer 504A. For example, as shown, each of the input nodes of the input layer 502 is connected to each of the nodes of the first hidden layer 504A. The nodes of the hidden layers 504 can transform the information of each input node by applying activation functions to the information. The information derived from the transformation can then be passed to, and activate, the nodes of the next hidden layer 504B, which can perform their own designated functions. Example functions include, without limitation, convolutional, up-sampling, data transformation, and/or any other suitable functions. The output of the hidden layer 504B can then activate nodes of the next hidden layer, and so on. The output of the last hidden layer 504N can activate one or more nodes of the output layer 506, which can then provide an output. In some cases, while nodes (e.g., 508) in the neural network 122 are shown as having multiple output lines, a node has a single output and all lines shown as being output from a node represent the same output value.

In some cases, each node or interconnection between nodes can have a weight that is a set of parameters derived from a training of the neural network 122. For example, an interconnection between nodes can represent a piece of information learned about the interconnected nodes. The interconnection can have a numeric weight that can be tuned (e.g., based on a training dataset), allowing the neural network 122 to be adaptive to inputs and able to learn as more and more data is processed.

The neural network 122 can be pre-trained to process the features from the data in the input layer 502 using the different hidden layers 504 in order to provide the output through the output layer 506. In an example in which the neural network 122 is used to detect features in an image, the neural network 122 can be trained using training data that includes image data.

The neural network 122 can be further trained as more input data, such as image data, is received. In some cases, the neural network 122 can be trained using supervised learning and/or reinforcement training. As the neural network 122 is trained, the neural network 122 can adjust the weights and/or biases of the nodes to optimize its performance.

In some cases, the neural network 122 can adjust the weights of the nodes using a training process such as backpropagation. Backpropagation can include a forward pass, a loss function, a backward pass, and a weight update. The forward pass, loss function, backward pass, and parameter update is performed for one training iteration. The process can be repeated for a certain number of iterations for each set of training data (e.g., image data) until the weights of the layers 502, 504, 506 in the neural network 122 are accurately tuned.

To illustrate, in the previous example of detecting features in an image, the forward pass can include passing image data samples through the neural network 122. The weights may be initially randomized before the neural network 122 is trained. For a first training iteration for the neural network 122, the output may include values that do not give preference to any particular feature, as the weights have not yet been calibrated. With the initial weights, the neural network 122 may be unable to detect some features and thus may yield poor detection results for some features. A loss function can be used to analyze the error in the output. Any suitable loss function definition can be used. One example of a loss function includes a mean squared error (MSE). The MSE is defined as Eₜₒₜₐₗ=Σ½(target−output)², which calculates the sum of one-half times the actual answer minus the predicted (output) answer squared. The loss can be set to be equal to the value of Eₜₒₜₐₗ.

The loss (or error) may be high for the first training image data samples since the actual values may be much different than the predicted output. The goal of training can be to minimize the amount of loss for the predicted output. The neural network 122 can perform a backward pass by determining which inputs (weights) most contributed to the loss of the neural network 122, and can adjust the weights so the loss decreases and is eventually minimized

A derivative of the loss with respect to the weights (denoted as dL/dW, where W are the weights at a particular layer) can be computed to determine the weights that most contributed to the loss of the neural network 122. After the derivative is computed, a weight update can be performed by updating all the weights of the filters. For example, the weights can be updated so they change in the opposite direction of the gradient. The weight update can be denoted as

$$w = {w}_{i} - η \frac{d L}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 122 can include any suitable neural network. One example includes a convolutional neural network (CNN), which includes an input layer and an output layer, with multiple hidden layers between the input and output layers. The hidden layers of a CNN include a series of convolutional, nonlinear, pooling, fully connected and normalization layers. The neural network 122 can include any other deep network, such as an autoencoder, a deep belief nets (DBNs), a Recurrent Neural Networks (RNNs), among others.

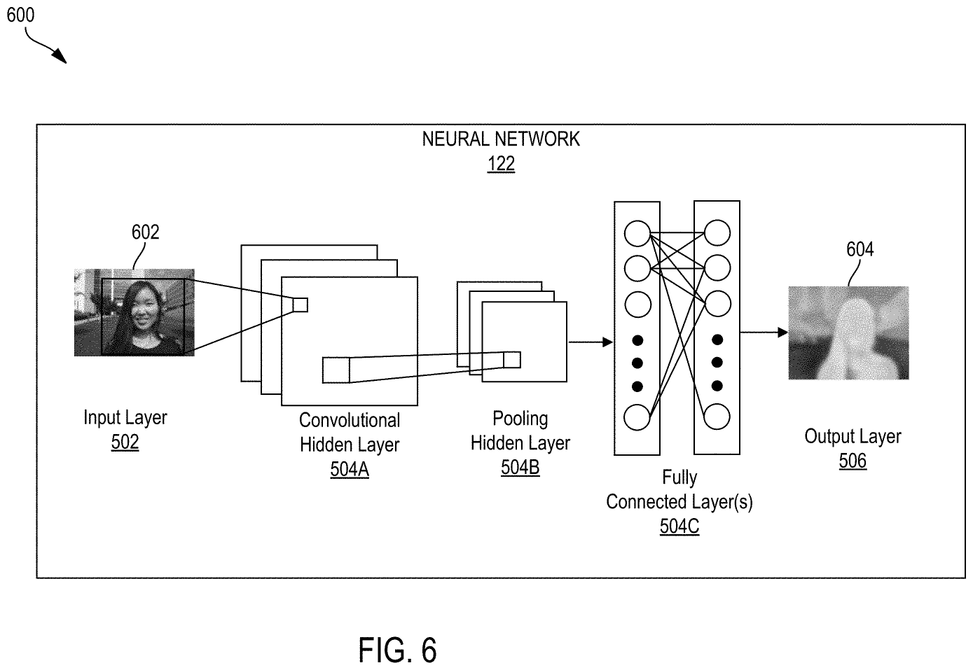

FIG. 6 illustrates an example use 600 of the neural network 122 for detecting features in an image. In this example, the neural network 122 includes an input layer 502, a convolutional hidden layer 504A, a pooling hidden layer 504B, fully connected layers 504C, and output layer 506. The neural network 122 can process an input image 602 to generate an output 604 representing features detected in the input image 602.

First, each pixel, superpixel or patch of pixels in the input image 602 is considered as a neuron that has learnable weights and biases. Each neuron receives some inputs, performs a dot product and optionally follows it with a non-linearity function. The neural network 122 can also encode certain properties into the architecture by expressing a differentiable score function from the raw image data (e.g., pixels) on one end to class scores at the other and process features from the image.

In some examples, the input layer 504A includes raw or captured image data. For example, the image data can include an array of numbers representing the pixels of an image (e.g., 602), with each number in the array including a value from 0 to 255 describing the pixel intensity at that position in the array. The image data can be passed through the convolutional hidden layer 504A, an optional non-linear activation layer, a pooling hidden layer 504B, and fully connected hidden layers 506 to get an output at the output layer 506. The output 604 can then identify features detected in the image data.

The convolutional hidden layer 504A can analyze the data of the input layer 502. Each node of the convolutional hidden layer 504A can be connected to a region of nodes (e.g., pixels) of the input data (e.g., image 602). The convolutional hidden layer 504A can be considered as one or more filters (each filter corresponding to a different activation or feature map), with each convolutional iteration of a filter being a node or neuron of the convolutional hidden layer 504A. Each connection between a node and a receptive field (region of nodes (e.g., pixels)) for that node learns a weight and, in some cases, an overall bias such that each node learns to analyze its particular local receptive field in the input image 602.

The convolutional nature of the convolutional hidden layer 504A is due to each node of the convolutional layer being applied to its corresponding receptive field. For example, a filter of the convolutional hidden layer 504A can begin in the top-left corner of the input image array and can convolve around the input data (e.g., image 602). As noted above, each convolutional iteration of the filter can be considered a node or neuron of the convolutional hidden layer 504A. At each convolutional iteration, the values of the filter are multiplied with a corresponding number of the original pixel values of the image. The multiplications from each convolutional iteration can be summed together to obtain a total sum for that iteration or node. The process is next continued at a next location in the input data (e.g., image 602) according to the receptive field of a next node in the convolutional hidden layer 504A. Processing the filter at each unique location of the input volume produces a number representing the filter results for that location, resulting in a total sum value being determined for each node of the convolutional hidden layer 504A.

The mapping from the input layer 502 to the convolutional hidden layer 504A can be referred to as an activation map (or feature map). The activation map includes a value for each node representing the filter results at each location of the input volume. The activation map can include an array that includes the various total sum values resulting from each iteration of the filter on the input volume. The convolutional hidden layer 504A can include several activation maps representing multiple feature spaces in the data (e.g., image 602).

In some examples, a non-linear hidden layer can be applied after the convolutional hidden layer 504A. The non-linear layer can be used to introduce non-linearity to a system that has been computing linear operations.

The pooling hidden layer 504B can be applied after the convolutional hidden layer 504A (and after the non-linear hidden layer when used). The pooling hidden layer 504B is used to simplify the information in the output from the convolutional hidden layer 504A. For example, the pooling hidden layer 504B can take each activation map output from the convolutional hidden layer 504A and generate a condensed activation map (or feature map) using a pooling function. Max-pooling is one example of a function performed by a pooling hidden layer. Other forms of pooling functions can be used by the pooling hidden layer 504B, such as average pooling or other suitable pooling functions.

A pooling function (e.g., a max-pooling filter) is applied to each activation map included in the convolutional hidden layer 504A. In the example shown in FIG. 6, three pooling filters are used for three activation maps in the convolutional hidden layer 504A. The pooling function (e.g., max-pooling) can reduce, aggregate, or concatenate outputs or feature representations in the input (e.g., image 602). Max-pooling (as well as other pooling methods) offer the benefit that there are fewer pooled features, thus reducing the number of parameters needed in later layers.

The fully connected layer 504C can connect every node from the pooling hidden layer 504B to every output node in the output layer 506. The fully connected layer 504C can obtain the output of the previous pooling layer 504B (which can represent the activation maps of high-level features) and determine the features or feature representations that provide the best representation of the data. For example, the fully connected layer 504C layer can determine the high-level features that provide the best or closest representation of the data, and can include weights (nodes) for the high-level features. A product can be computed between the weights of the fully connected layer 504C and the pooling hidden layer 504B.

The output 604 from the output layer 506 can include an indication of features detected or extracted from the input image 602. In some examples, the output from the output layer 506 can include patches of output that are then tiled or combined to produce a final rendering or output (e.g., 604). Other example outputs can also be provided. Moreover, in some examples, the features in the input image can be derived using the response from different levels of convolution layers from any object recognition, detection, or semantic segmentation convolution neural network.

While the example above describes a use of the neural network 122 to extract image features, it should be noted that this is just an illustrative example provided for explanation purposes and, in other examples, the neural network 122 can also be used for other tasks. For example, in some implementations, the neural network 122 can be used to refine a disparity map (e.g., 310, 410) derived from one or more sensors. To illustrate, in some implementations, the left and right sub-pixels in the sensor can be used to compute the disparity information in the input image. When the distance between the left and right sub-pixels are too close, the disparity information can become limited when the object is distant. Therefore, a neural network can be used to optimize the disparity information and/or refine the disparity map using sub-pixels.

Having disclosed example systems and concepts, the disclosure now turns to the example method 700 shown in FIG. 7. For the sake of clarity, the method 700 is described with reference to the image processing system 100, as shown in FIG. 1, configured to perform the various steps in the method 700. The steps outlined herein are examples and can be implemented in any combination thereof, including combinations that exclude, add, or modify certain steps.

The method 700 can be implemented to perform various image processing tasks and/or effects. For example, in some cases, the method 700 can be implemented to produce an image segmentation-based effect, such as a depth-of-field effect, a chroma keying effect, an image stylization effect, an artistic effect, a computational photography effect, among others. In other examples, the method 700 can be implemented to perform other image-segmentation based effects or processing tasks such as, for example and without limitation, feature extraction, image recognition (e.g., object or face recognition), machine vision, medical imaging, and/or any other image-segmentation based effects or processing tasks.

At step 702, the image processing system 100 can detect (e.g., via image processing engine 120 and/or neural network 122) a set of superpixels in an image (e.g., input image 202, 242, 302, or 402). The set of superpixels can represent different segments or regions of the image and each superpixel can include a group of pixels (e.g., two or more pixels) as previously described. The image can be an input image received by the image processing system 100 for processing to create an effect, such as a depth-of-field or bokeh effect, on one or more regions (e.g., a background and/or foreground region) of the image.

In some examples, the image processing system 100 can obtain the image from an image sensor (e.g., 102, 104) or camera device that captured the image. The image sensor or camera device can be part of or implemented by the image processing system 100, or separate from the image processing system 100. In other examples, the image processing system 100 can obtain the image from any other source such as a server, a storage, or a remote computing system.

In some implementations, the image processing system 100 can detect or extract the superpixels in the image using a superpixel segmentation algorithm, such as a SLIC algorithm which can perform local clustering of pixels. The superpixel extraction or detection can help preserve image structures while abstracting unnecessary details, and the superpixels can serve as the computational unit for ranking as described below at step 708.

In some examples, the image processing system 100 can also analyze the image to detect or extract (e.g., via image processing engine 120 and/or neural network 122) features in the image. For example, the image processing system 100 can analyze the image and extract feature information from each superpixel. In some examples, the image processing system 100 can extract features or superpixels in the image using a neural network (e.g., 122), such as a convolutional neural network. Moreover, the features detected in the image can include color information (e.g., color components or channels), texture information, semantic information, etc. The semantic information or features can include, for example and without limitation, visual contents of the image such as objects present in the image, a scene in the image, a context related to the image, a concept related to the image, etc.

In some implementations, when extracting or detecting color features, the image processing system, 100 can record each pixel in a particular color space (e.g., CIE L*a*b*) to a three-dimensional (3D) vector. Further, when extracting or detecting semantic features, the image processing system, 100 can extract and combine the result from a convolutional neural network at mid-level and high-level stages. The image processing system 100 can also use principal component analysis (PCA) to reduce the original dimensional vectors associated with the semantic features to 3D vectors and normalize them to use 0 or 1 values (e.g., [0, 1]).

At step 704, the image processing system 100 can identify, based on a disparity map generated for the image, an image region (e.g., region of interest 312 or 412) containing at least a portion of a foreground of the image. For example, the image processing system 100 can identify a portion of superpixels estimated to represent or contain at least a portion of the foreground of the image or a region of interest. In some implementations, the disparity map can be a binarized disparity map (e.g., 310 or 410) associated with the image.

For example, in some cases, the image processing system 100 can obtain a disparity map or “depth map” for the image and binarize the disparity map to values of 0 or 1 (e.g., [0, 1]), which can provide an indication of the potential location of a target or object of interest in the image or FOV. In some cases, the disparity map can represent apparent pixel differences, motion, or depth (the disparity). Typically, objects that are close to the image sensor that captured the image will have greater separation or motion (e.g., will appear to move a significant distance) while objects that are further away will have less separation or motion. Such separation or motion can be captured by the disparity values in the disparity map. Thus, the disparity map can provide an indication of which objects are likely within a region of interest (e.g., the foreground), and which are likely not within the region of interest.

In some cases, the disparity information for the disparity map can be obtained from hardware (e.g., an image sensor or camera device). For example, the disparity map can be generated based on auto-focus information from hardware (e.g., image sensor, camera, etc.) used to produce the image. The auto-focus information can help identify where a target or object of interest (e.g., a foreground object) is likely to be in the FOV. To illustrate, an auto-focus function can be leveraged to help the image processing system 100 identify where the target or object of interest is likely to be in the FOV. In some examples, an auto-focus function on hardware can automatically adjust a lens setting to set the optical focal points on the target or object of interest. When the image processing system 100 checks the disparity map, the scene behind the target or object of interest can have a negative disparity value, while the scene before the target or object of interest can have a positive disparity value and areas around the target or object of interest can contain a disparity value closer to zero.

Therefore, the image processing system 100 can generate a binarized disparity map based on a threshold such as, for example, [−delta, delta] with delta being a smaller positive value for screening. For example, for a region with a disparity value in the [−delta, delta] range, the image processing system 100 can assign the region a value of 1, and zero otherwise. The value of 1 in the binarized disparity map can indicate the focused area (e.g., the region(s) where the target or object of interest may appear).

In some example dual image sensor or camera implementations, the disparity information can be derived using stereo vision or LIDAR techniques. In some implementations, such as a single camera or monocular camera implementations, the disparity information can be derived using phase detection (PD). For example, the disparity can be derived from PD pixels.

In some implementations, the image processing system 100 can identify the image region based on both the disparity map and a spatial prior map associated with the image. The image processing system 100 can obtain the spatial prior map for the image based on the set of superpixels. The spatial prior map can include spatial prior information, and can represent the probability or likelihood that one or more objects are located in a center region of the image as opposed to a border region(s) of the image. To identify the image region, the image processing system 100 can normalize the spatial prior map to [0, 1] and modify the normalized spatial prior map with the binarized disparity map. By modifying the normalized spatial prior map with the binarized disparity map, the image processing system 100 can more accurately identify the image region of interest.

At step 706, the image processing system 100 can calculate one or more foreground queries identifying a portion of superpixels in the foreground of the image. The one or more foreground queries can indicate which superpixels (e.g., the portion of superpixels) are estimated to belong to the foreground. In some examples, the one or more foreground queries can include at least one superpixel in a foreground region of the image. In some cases, the at least one superpixel can have a higher saliency value than one or more other superpixels in the image. The at least one superpixel identified can represent the one or more foreground queries.

Moreover, the image processing system 100 can calculate the one or more foreground queries based on the set of superpixels and the image region identified at step 704. In some cases, the image processing system 100 can calculate the one or more foreground queries based on saliency values corresponding to the superpixels in the image region and/or the set of superpixels in the image. The portion of superpixels identified by the one or more foreground queries can include one or more superpixels in the image having higher saliency values than one or more other superpixels in the image.

To illustrate, in some examples, the image processing system 100 can calculate a mean saliency value for each superpixel in the image and select one or more superpixels having the highest mean saliency value(s) or having the top n mean saliency values, where n is a percentage of all mean saliency values associated with all the superpixels in the image. The one or more superpixels selected can represent or correspond to the one or more foreground queries.

In some aspects, the one or more foreground queries can include one or more superpixels labeled as 1 to indicate that the one or more superpixels are foreground superpixels. Moreover, in some examples, superpixels estimated to be foreground superpixels may be unlabeled. In such examples, the unlabeled superpixels can indicate that such superpixels are foreground superpixels.

At step 708, the image processing system 100 can rank a relevance between each superpixel in the set of superpixels and at least some of the one or more foreground queries. For example, in some cases, the image processing system 100 can rank a relevance between at least one superpixel corresponding to the one or more foreground queries and other superpixels from the set of superpixels in the image. In another example, the image processing system 100 can rank a cumulative relevance between the one or more foreground queries (e.g., one or more superpixels being labeled as 1 to indicate that the one or more superpixels are foreground superpixels) with respect to unlabeled superpixels (e.g., background superpixels) in the image.

Moreover, in some examples, at step 708, the image processing system 100 can perform manifold ranking using the one or more foreground queries (e.g., the at least one superpixel) and the set of superpixels in the image. The manifold ranking can have a closed form, thus enabling efficient computation.

In some cases, the image processing system 100 can also use features (e.g., color, texture, semantic features, etc.) detected in the image to perform the manifold ranking In some examples, the image processing system 100 can use the set of superpixels and the detected features to construct a graph used with the one or more foreground queries to generate a manifold ranking result.

In some examples, the ranking at step 708 can produce a ranking map S. The image processing system 100 can generate the ranking map S using a ranking vector ƒ* generated based on Equation (4) described above. In some examples, the image processing system 100 can normalize the ranking vector ƒ* between the range of 0 and 1 to form the ranking map S. The ranking map S can represent or convey a saliency ranking of superpixels in the image. Moreover, by computing the regional relevance of an image with the selected foreground queries, the image processing system 100 can efficiently reconstruct all the areas in the region of interest.

At step 710, the image processing system 100 can generate a saliency map for the image based on the ranking of the relevance between each superpixel in the set of superpixels and at least some of the one or more foreground queries. For example, the image processing system 100 can generate the saliency map based on a ranking map S produced based on the ranking results. In some cases, to generate the saliency map, the image processing system 100 can perform saliency refinement for the ranking map S. The saliency refinement can be used to improve spatial coherence, for example.

In some cases, the saliency refinement can be performed using a pixel-wise saliency refinement model. For example, in some implementations, the saliency refinement can be performed based on a fully connected conditional random field (CRF). In other implementations, image matting can be used to perform the saliency refinement. Image matting is an image processing technique that can be used to extract one or more objects or layers (e.g., foreground and/or background) from an image by feature (e.g., color) and alpha estimation. In some examples, the image matting techniques herein can use the saliency map as prior information. The prior information can be used to obtain a matte (e.g., a transparency value a of 0 or 1 at each pixel) such that the color value at each pixel can be deconstructed into a sum of a sample from a foreground color and a sample from a background color. Additional matting can be performed to identify and improve inaccurate or incorrect pixels and further optimize the matte. The results (e.g., the optimized matte or values) can then be used to refine saliency values or results for saliency refinement.

The saliency map can be a refined saliency map produced based on the saliency refinement performed on the ranking map S. In some examples, the image processing system 100 can generate the saliency map based on a respective probability of each pixel or superpixel being salient, which can be determined based on the ranking map S.

At step 712, the image processing system 100 can generate, based on the saliency map, an output image (e.g., output image 320 or 420) having an effect applied to a portion of the image. In some implementations, the effect can be a blurring effect applied to a portion of the image, such as a background region of the image. The blurring effect can be part of a depth-of-field or bokeh effect, where a portion of the output image is blurred and another portion of the output image is in focus. In some examples, the portion of output image blurred can be a background portion of the output image, and the other portion that is in focus can be a foreground portion of the output image. In other implementations, the effect can be a different image segmentation-based effect such as a green screening effect (e.g., chroma key compositing) for example.

In some cases, after generating the saliency map at step 710, instead of generating the output image at step 712, the image processing system 100 can binarize the saliency map and use the binarized saliency map to perform an iterative refinement process to achieve progressive improvements in saliency detection quality or accuracy. In the iterative refinement process, the image processing system 100 can perform steps 706 through 710 in one or more iterations or rounds until, for example, a specific or desired saliency result is obtained. Thus, instead of proceeding to step 712 after completing step 710, in some cases, the image processing system 100 can proceed back to step 706 to start another iteration of steps 706 through 710. After the iteration is complete and a new or updated saliency map is generated at step 710, the image processing system 100 can proceed to step 712 or back to step 706 for another iteration of steps 706 through 710.

For example, the image processing system 100 can use the binarized saliency map to calculate new, refined, or updated foreground queries at step 706. The image processing system 100 can use the new, refined, or updated foreground queries to perform manifold ranking as previously described. At step 708, the image processing system 100 can then generate a new, refined, or updated ranking map S based on the manifold ranking results. The image processing system 100 can also perform saliency refinement as previously described, and generate a new, refined, or updated saliency map at step 710. The image processing system 100 can then use the new, refined, or updated saliency map to generate the output image at step 712; or use a binarized version of the new, refined, or updated saliency map to perform another iteration of steps 706 through 710.

In some cases, when performing another iteration of steps 706 through 710, the binarized version of the saliency map generated at step 710 can help improve the quality or accuracy of the foreground queries calculated at step 706. This in turn can also help improve the quality or accuracy of the results or calculations at steps 708 and 710. Thus, in some cases, the additional iteration(s) of steps 706 through 710 can produce a saliency map of progressively higher quality or accuracy, which can be used to generate an output image of higher quality or accuracy (e.g., better field-of-view effect, etc.).

As illustrated above, the method 700 and the approaches herein can be implemented to segment arbitrary objects in a wide range of scenes by distilling foreground cues from a disparity map, including a low-resolution disparity map. Moreover, the method 700 and the approaches herein can be implemented by any image data capturing devices, including single lens or monocular camera implementations, for segmentation to bring an entire object into focus. Further, the segmentation algorithm with the ranking described herein can have a closed form, and thus enables efficient computation and provides wide flexibility which allows it to be implemented in hardware and/or software.

Furthermore, by combining use of disparity information with image saliency detection, the method 700 and the approaches herein can also enable depth-assisted and object-aware auto exposure, auto white balance, auto-focus, and many other functions. In such cases, the auto exposure can help better control the exposure on the focusing objects, the auto white balance can help better reproduce the color of the target object, and the auto-focus can help refine its focus value according to the refined disparity map guided saliency map.

In some examples, the method 700 can be performed by a computing device or an apparatus such as the computing device 800 shown in FIG. 8, which can include or implement the image processing system 100 shown in FIG. 1. In some cases, the computing device or apparatus may include a processor, microprocessor, microcomputer, or other component of a device that is configured to carry out the steps of method 700. In some examples, the computing device or apparatus may include an image sensor (e.g., 102 or 104) configured to capture images and/or image data. For example, the computing device may include a mobile device with an image sensor (e.g., a digital camera, an IP camera, a mobile phone or tablet including an image capture device, or other type of device with an image capture device). In some examples, an image sensor or other image data capturing device can be separate from the computing device, in which case the computing device can receive the captured images or image data.

In some cases, the computing device may include a display for displaying the output images. The computing device may further include a network interface configured to communicate data, such as image data. The network interface may be configured to communicate Internet Protocol (IP) based data or other suitable network data.

Method 700 is illustrated as a logical flow diagram, the steps of which represent a sequence of steps or operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like, that perform particular functions or implement particular data types. The order in which the operations are described is not intended to be construed as a limitation or requirement, and any number of the described operations can be combined in any order and/or in parallel to implement the processes.

Additionally, the method 700 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

As noted, the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. Therefore, the computer-readable medium may be understood to include one or more computer-readable media of various forms, in various examples.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

The various illustrative logical blocks, modules, circuits, and algorithm steps described in connection with the features disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding or incorporated in a combined video encoder-decoder (CODEC).

FIG. 8 illustrates an example computing device architecture of an example computing device 800 which can implement the various techniques described herein. For example, the computing device 800 can implement the image processing system 100 shown in FIG. 1 and perform the image processing techniques described herein.

The components of the computing device 800 are shown in electrical communication with each other using a connection 805, such as a bus. The example computing device 800 includes a processing unit (CPU or processor) 810 and a computing device connection 805 that couples various computing device components including the computing device memory 815, such as read-only memory (ROM) 820 and random access memory (RAM) 825, to the processor 810. The computing device 800 can include a cache of high-speed memory connected directly with, in close proximity to, or integrated as part of the processor 810. The computing device 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions.

Other computing device memory 815 may be available for use as well. The memory 815 can include multiple different types of memory with different performance characteristics. The processor 810 can include any general purpose processor and hardware or software service, such as service 1 832, service 2 834, and service 3 836 stored in storage device 830, configured to control the processor 810 as well as a special-purpose processor where software instructions are incorporated into the processor design. The processor 810 may be a self-contained system, containing multiple cores or processors, a bus, memory controller, cache, etc. A multi-core processor may be symmetric or asymmetric.

To enable user interaction with the computing device 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art, such as a display, projector, television, speaker device, etc. In some instances, multimodal computing devices can enable a user to provide multiple types of input to communicate with the computing device 800. The communications interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof.

The storage device 830 can include services 832, 834, 836 for controlling the processor 810. Other hardware or software modules are contemplated. The storage device 830 can be connected to the computing device connection 805. In one aspect, a hardware module that performs a particular function can include the software component stored in a computer-readable medium in connection with the necessary hardware components, such as the processor 810, connection 805, output device 835, and so forth, to carry out the function.

For clarity of explanation, in some instances, the present technology may be presented as including individual functional blocks including functional blocks comprising devices, device components, steps or routines in a method embodied in software, or combinations of hardware and software.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods, according to the above-described examples, can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components, computing devices and methods within the scope of the appended claims.

Claim language reciting “at least one of” a set indicates that one member of the set or multiple members of the set satisfy the claim. For example, claim language reciting “at least one of A and B” means A, B, or A and B.

What is claimed is:

1. A method comprising:
identifying at least one superpixel in a foreground region of an image, each superpixel comprising two or more pixels, and the at least one superpixel having a higher saliency value than one or more other superpixels in the image;
ranking a relevance between the at least one superpixel and each superpixel from the one or more other superpixels in the image; and
generating a saliency map for the image based on the ranking of the relevance between the at least one superpixel and each superpixel from the one or more other superpixels in the image.

2. The method of claim 1, further comprising detecting a set of features in the image, wherein the ranking of the relevance between the at least one superpixel and each superpixel from the one or more other superpixels in the image is at least partly based on the set of features in the image.

3. The method of claim 2, wherein the set of features is detected using a trained network, and wherein the set of features comprises at least one of semantic features, texture information, and color components.

4. The method of claim 1, further comprising:
based on the saliency map, generating an edited output image having a blurring effect applied to a portion of the image, wherein the portion of the image comprises a background image region, and wherein the blurring effect comprises a depth-of-field effect where the background image region is at least partly blurred and the foreground region of the image is at least partly in focus.

5. The method of claim 1, further comprising:
identifying a region of interest in the image, the region of interest comprising at least a portion of the foreground region of the image.

6. The method of claim 5, wherein identifying the region of interest in the image s based on at least one of a spatial prior map of the image and a disparity map generated for the image.

7. The method of claim 5, wherein identifying the region of interest in the image comprises:
generating a spatial prior map of the image based on a set of superpixels in the image, the set of superpixels comprising the at least one superpixel and the one or more other superpixels;
generating a binarized disparity map based on the disparity map generated for the image;
multiplying the spatial prior map with the binarized disparity map; and
identifying the region of interest in the image based on an output generated by multiplying the spatial prior map with the binarized disparity map.

8. The method of claim 7, wherein the disparity map is generated based on autofocus information from an image sensor that captured the image, and wherein the binarized disparity map identifies at least a portion of the foreground region in the image based on one or more associated disparity values.

9. The method of claim 1, wherein identifying the at least one superpixel in the foreground region of the image comprises:
calculating mean saliency values for superpixels in the image, each of the superpixels comprising two or more pixels;
identifying the at least one superpixel having the higher mean saliency value than the one or more other superpixels in the image; and
selecting the at least one superpixel as a foreground query, wherein the ranking of the relevance between the at least one superpixel and each superpixel from the one or more other superpixels in the image comprises ranking the relevance between the foreground query and each superpixel from the one or more other superpixels.

10. The method of claim 1, wherein the ranking of the relevance between the at least one superpixel and each superpixel from the one or more other superpixels in the image is based on one or more manifold ranking functions, wherein an input of the one or more manifold ranking functions comprises at least one of a set of superpixels in the image, the at least one superpixel in the foreground region of the image, and a set of features extracted from the image.

11. The method of claim 1, wherein ranking of the relevance between the at least one superpixel and each superpixel from the one or more other superpixels in the image comprises generating a ranking map based on a set of superpixels in the image, the at least one superpixel in the foreground region of the image, and a set of features extracted from the image, and wherein the saliency map is generated based on the ranking map.

12. The method of claim 11, wherein generating the saliency map comprises:
applying a pixel-wise saliency refinement model to the ranking map, the pixel-wise saliency refinement model comprising one of a fully-connected conditional random field or an image matting model; and
generating the saliency map based on a result of applying the pixel-wise saliency refinement model to the ranking map.

13. The method of claim 12, further comprising:
binarizing the saliency map;
generating one or more foreground queries based on the binarized saliency map, the one or more foreground queries comprising one or more superpixels in the foreground region of the image;
generating an updated ranking map based on the one or more foreground queries and the set of superpixels in the image;
applying the pixel-wise saliency refinement model to the updated ranking map; and
generating a refined saliency map based on an additional result of applying the pixel-wise saliency refinement model to the updated ranking map.

14. The method of claim 13, further comprising:
based on the refined saliency map, generating an edited output image having an effect applied to at least a portion of a background region of the image.

15. An apparatus comprising:
a memory; and
a processor configured to:
identify at least one superpixel in a foreground region of an image, each superpixel comprising two or more pixels, and the at least one superpixel having a higher saliency value than one or more other superpixels in the image;
rank a relevance between the at least one superpixel and each superpixel from the one or more other superpixels in the image; and
generate a saliency map for the image based on the ranking of the relevance between at least one superpixel and each superpixel from the one or more other superpixels in the image.

16. The apparatus of claim 15, wherein the processor is configured to:
detect a set of features in the image, wherein the ranking of the relevance between the at least one superpixel and each superpixel from the one or more other superpixels in the image is at least partly based on the set of features in the image.

17. The apparatus of claim 16, wherein the set of features is detected using a convolutional neural network, and wherein the set of features comprises at least one of semantic features, texture information, and color components.

18. The apparatus of claim 15, wherein the processor is configured to:
generate, based on the saliency map, an edited output image having a blurring effect applied to a portion of the image, wherein the portion of the image comprises a background image region, and wherein the blurring effect comprises a depth-of-field effect where the background image region is at least partly blurred and the foreground region of the image is at least partly in focus.

19. The apparatus of claim 15, wherein the processor is configured to:
detect a set of superpixels in the image, wherein the set of superpixels comprises the at least one superpixel and the one or more other superpixels, and wherein each superpixel in the set of superpixels comprises at least two pixels.

20. The apparatus of claim 15, wherein the processor is configured to:
identify a region of interest in the image, the region of interest comprising at least a portion of the foreground region of the image.

21. The apparatus of claim 20, wherein identifying the region of interest in the image is based on at least one of a spatial prior map of the image and a disparity map generated for the image.

22. The apparatus of claim 20, wherein identifying the region of interest in the image comprises:
generating a spatial prior map of the image based on a set of superpixels in the image, the set of superpixels comprising the at least one superpixel and the one or more other superpixels;
generating a binarized disparity map based on a disparity map generated for the image, wherein the binarized disparity map identifies at least a portion of the foreground region in the image based on one or more associated disparity values;
multiplying the spatial prior map with the binarized disparity map; and
identifying the region of interest in the image based on an output generated by multiplying the spatial prior map with the binarized disparity map.

23. The apparatus of claim 15, wherein identifying the at least one superpixel in the foreground region of the image comprises:
calculating mean saliency values for superpixels in the image, each of the superpixels comprising two or more pixels;
identifying the at least one superpixel having the higher mean saliency value than the one or more other superpixels in the image; and
selecting the at least one superpixel as a foreground query, wherein the ranking of the relevance between the at least one superpixel and each superpixel from the one or more other superpixels in the image comprises ranking the relevance between the foreground query and each superpixel from the one or more other superpixels.

24. The apparatus of claim 15, wherein the ranking of the relevance between the at least one superpixel and each superpixel from the one or more other superpixels in the image is based on one or more manifold ranking functions, wherein an input of the one or more manifold ranking functions comprises at least one of a set of superpixels in the image, the at least one superpixel in the foreground region of the image, and a set of features extracted from the image.

25. The apparatus of claim 15, wherein ranking of the relevance between the at least one superpixel and each superpixel from the one or more other superpixels in the image comprises generating a ranking map based on a set of superpixels in the image, the at least one superpixel in the foreground region of the image, and a set of features extracted from the image, and wherein the saliency map is generated based on the ranking map.

26. The apparatus of claim 25, wherein generating the saliency map comprises:
applying a pixel-wise saliency refinement model to the ranking map, the pixel-wise saliency refinement model comprising one of a fully-connected conditional random field or an image matting model; and
generating the saliency map based on a result of applying the pixel-wise saliency refinement model to the ranking map.

27. The apparatus of claim 26, wherein the processor is configured to:
binarize the saliency map;
generate one or more foreground queries based on the binarized saliency map, the one or more foreground queries comprising one or more superpixels in the foreground region of the image;
generate an updated ranking map based on the one or more foreground queries and the set of superpixels in the image;
apply the pixel-wise saliency refinement model to the updated ranking map; and
generate a refined saliency map based on an additional result of applying the pixel-wise saliency refinement model to the updated ranking map.

28. The apparatus of claim 27, wherein the processor is configured to:
generate, based on the refined saliency map, an edited output image having an effect applied to at least a portion of a background region of the image.

29. The apparatus of claim 15, further comprising at least one of a mobile phone, an image sensor, and a smart wearable device.

30. A non-transitory computer-readable storage medium comprising:
instructions stored therein instructions which, when executed by one or more processors, cause the one or more processors to:
identify at least one superpixel in a foreground region of an image, each superpixel comprising two or more pixels, and the at least one superpixel having a higher saliency value than one or more other superpixels in the image;
rank a relevance between the at least one superpixel and each superpixel from the one or more other superpixels in the image;
generate a saliency map for the image based on the ranking of the relevance between the at least one superpixel and each superpixel from the one or more other superpixels in the image; and
generate, based on the saliency map, an edited output image having an effect applied to at least one portion of the image, wherein the at least one portion of the image comprises at least one of a background image region and the foreground region of the image.
